(19) United States
(12) Patent Application Publication
(10) Pub. No.: US 2011/0278317 A1
(43) Pub. Date: Nov. 17, 2011

(54) BARRIER-TYPE CONTAINER MADE OF PLASTICS

(76) Inventors: Claudio Chiari, Gattatico (IT); Erika Chiari, Bazzano (IT)

(21) Appl. No.: 13/138,259

(22) PCT Filed: Jan. 21, 2010
(86) PCT No.: PCT/EP2010/050691

§ 371 Date: Jul. 25, 2011

(30) Foreign Application Priority Data
Jan. 27, 2009 (IT) MO2009A000017

(51) Int. Cl. B65D 25/00; B29C 45/14

(52) U.S. Cl. 220/729; 156/245

(57) ABSTRACT

A barrier-type container made of plastics, comprising a stiffening structure made of plastics which is obtained by injection-molding or blow-molding and at least one barrier element made of a flexible aluminum sheet, which are directly joined at at least one respective portion, the barrier element being sealable to at least the stiffening structure.

The present invention relates to a barrier-type container made of rigid or semirigid plastics.

### BACKGROUND OF THE INVENTION

Barrier-type containers are known which allow the packaging of products so as to obtain perfect insulation with respect to the surrounding environment, in order to preserve their characteristics intact, i.e., so as to not contaminate the surrounding environment.

In the food sector, for example, these containers are widely used in order to reduce the penetration of oxygen and moisture, so as to protect the shelf life of packaged products.

Barrier-type containers made of plastics are generally of a flexible type, such as pouches or bags, and are obtained by processing substrates made of plastics which are coupled or co-extruded.

However, these containers of a flexible type are not free from drawbacks, which include the fact that their irregular shape does not allow their stacking, making it necessary to use secondary packages, which enclose a plurality of containers, in order to allow their handling and storage. Display in the point of sale, moreover, also can be difficult and may require the use of auxiliary supports.

### SUMMARY OF THE INVENTION

The aim of the present invention is to eliminate the drawbacks cited above of the background art, by providing a barrier-type container made of plastics which is rigid or semirigid and has a definite shape so as to allow an easy juxtaposition and stacking thereof during handling and storage as well as during display at the point of sale.

Within this aim, an object of the present invention is to have a production cycle that is simple and does not entail high costs and long times for processing.

Another object of the present invention is to provide a container that can be closed again after its first opening, being practical to use for consumers of the products packaged therein.

Another object of the present invention is to be flexible in use, adapting to the specific technical requirements linked to the packaging of the respective product as well as to the display requirements thereof.

Another object of the present invention is to ensure total insulation of the packaged product with respect to the surrounding environment.

Another object of the present invention is to have a structure which is simple, relatively easy to provide in practice, safe to use and effective in operation, as well as relatively low in cost.

This aim and these and other objects which will become better apparent hereinafter are achieved by the present barrier-type container made of plastics, characterized in that it comprises a stiffening structure made of plastics which is obtained by injection-molding or blow-molding and at least one barrier element made of a flexible aluminum sheet, which are directly joined at least one respective portion, the barrier element being sealable to at least the stiffening structure.

### BRIEF DESCRIPTION OF THE DRAWINGS

Further characteristics and advantages of the present invention will become better apparent from the following detailed description of some preferred but not exclusive embodiments of a barrier-type container made of plastics, illustrated by way of non-limiting example in the accompanying drawings, wherein:

FIG. 1 is a schematic perspective view of a first embodiment of a container according to the invention;

FIG. 2 is a schematic sectional view of the container of FIG. 1;

FIGS. 3-6 are schematic views of successive steps of the process for the production of the container of the preceding figures;

FIG. 7 is a schematic perspective view of a second embodiment of the container according to the invention;

FIG. 8 is a schematic sectional view of the container of FIG. 7;

FIGS. 9-12 are schematic views of successive steps of the method for production of the container of FIGS. 7-8;

FIG. 13 is a schematic perspective view of a third embodiment of the container according to the invention;

FIG. 14 is a schematic sectional view of the container of FIG. 13;

FIG. 15 is a schematic perspective view of a fourth embodiment of the container according to the invention;

FIG. 16 is a schematic sectional view of the container of FIG. 15 inside the mold for blow-molding;

FIG. 17 is a schematic perspective view of a fifth embodiment of the container according to the invention;

FIG. 18 is a schematic sectional view of the container of FIG. 17;

FIGS. 19-21 are schematic views of successive steps of the method for producing the container of FIGS. 17-18;

FIG. 22 is a schematic perspective view of a first embodiment of a lid of the container according to the invention;

FIGS. 23-24 are schematic views of successive steps of the method for producing the lid of FIG. 22;

FIGS. 25-28 are schematic views of successive steps of the method for producing a second embodiment of a lid of the container according to the invention.

### DESCRIPTION OF THE PREFERRED EMBODIMENTS

With reference to the figures, the reference numeral 1 generally designates a barrier container made of plastics.

The container 1 comprises a stiffening structure 2 made of plastics, which is obtained by injection-molding or blow-molding, and at least one barrier element 3a, 3b, 3c, 3d, 3e, 3f made of a flexible aluminum sheet, which are directly joined at least one respective portion. At least one between the stiffening structure 2 and the barrier element 3a, 3b, 3c, 3d, 3e, 3f forms a concave surface for containing one or more products to be packaged.

The expression “directly joined” is used to mean that the stiffening structure 2 and the barrier element 3a, 3b, 3c, 3d, 3e, 3f are cohesively in contact with each other, without the interposition of auxiliary materials.

Plastics used to provide the stiffening structure 2 can be of the type of polyethylene or polypropylene, depending on the compatibility with the products to be packaged.

The barrier element 3a, 3b, 3c, 3d, 3e, 3f is processed by die-cutting a flexible sheet based on aluminum or alloys thereof obtained by rolling. Advantageously, the material in sheet form from which the barrier element 3a, 3b, 3c, 3d, 3e, 3f is obtained has undergone, on at least one of the two mutually opposite faces, a treatment for coating with such materials as to make it sealable to at least the plastics of which the stiffening structure 2 is made and preferably also sealable onto itself, these treatments being of a known type. The material in sheet form thus obtained is known conventionally as of the “double-sealing” type.

The container 1 can be used for example for the packaging of food products, pharmaceutical products, chemical products in general, both in the solid state and in the liquid state.

In a possible embodiment, the container 1 is rigid and the stiffening structure 2 provides a vessel 4 provided with a bottom wall 4a from which a lateral wall 4b protrudes which forms, on the opposite side of such bottom wall, an open mouth 4c.

The container 1 can have at least two barrier elements, a first element 3a for covering the bottom wall 4a and a second element 3b for covering the side wall 4b, the vessel 4 being obtained by injection-molding. The first barrier element 3a is arranged so as to cover the bottom wall 4a on the side directed toward the inside of the container 1.

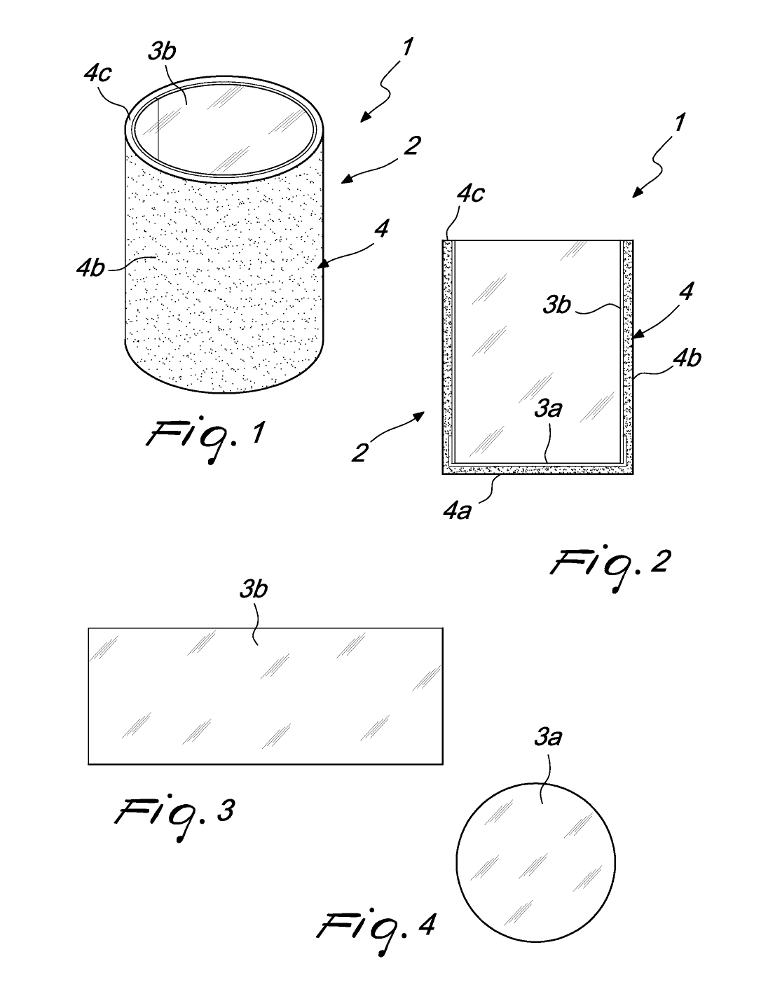

In a first embodiment (FIGS. 1 and 2), the second barrier element 3b is arranged so as to cover the side wall 4b on the side that is directed toward the inside of the container 1.

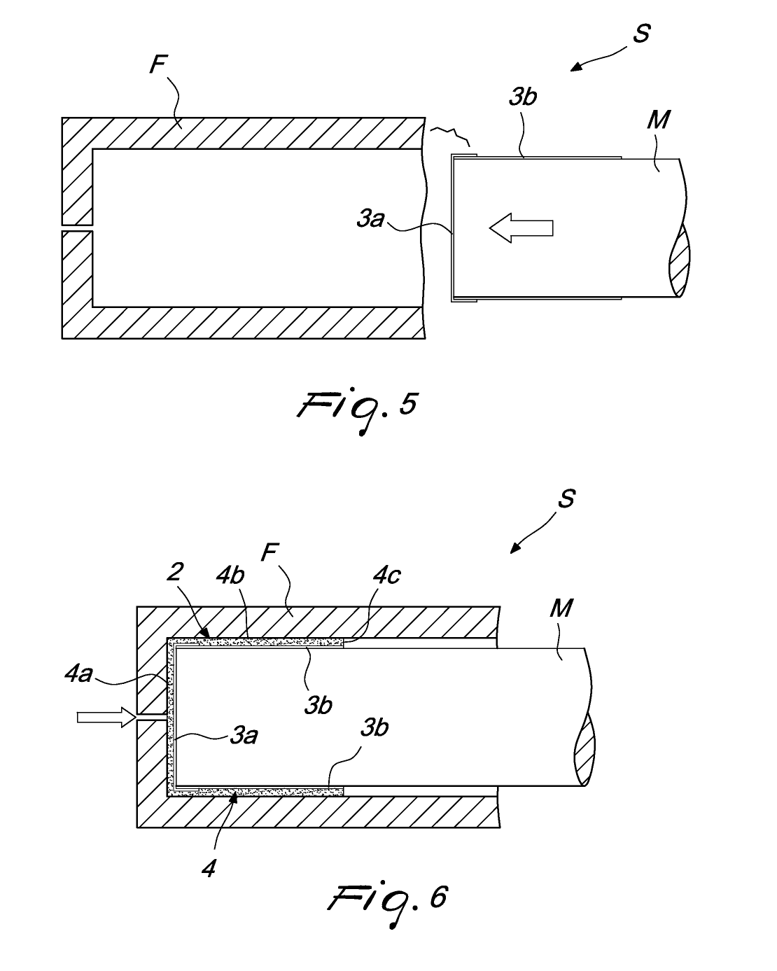

The method for obtaining the container 1 (FIGS. 3-6) entails:
shaping by die-cutting the first barrier element 3a, which has a larger extension than the bottom wall 4a, and the second barrier element 3b, shaped like a band, from a flexible aluminum sheet;
arranging the first barrier element 3a at the bottom of the plug that acts as a male mold half M and the second barrier element 3b wrapped so as to adhere to such plug. It is possible to seal the second barrier element 3b along the mutually opposite sides so as to obtain a closed band. The first barrier element 3a is kept in position by means of the vacuum provided inside the male mold half M (which is internally hollow);
closing the mold S by moving the male mold half M and the female mold half F mutually closer. In the closure of the mold S, the peripheral portion of the first barrier element 3a that protrudes beyond the extension of the bottom wall 4a folds onto the second barrier element 3b, so as to seal its joint;
injecting plastics into the mold S;
shaping the stiffening structure 2 made of plastics within the mold S directly on the barrier elements 3a and 3b. The stiffening structure 2 that is obtained is directly and integrally (i.e., on the entire surface in contact) cohesive with the barrier elements 3a and 3b so as to form a barrier-type container 1.

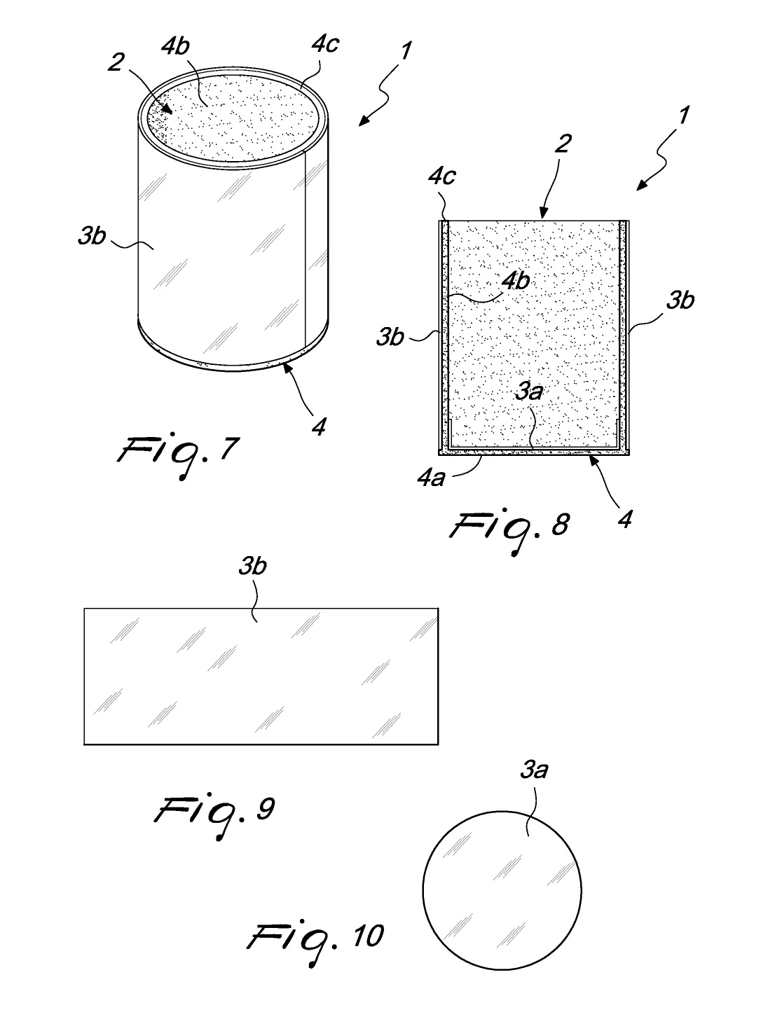

In a second embodiment (FIGS. 7-8), the second barrier element 3b is arranged so as to cover the side wall 4b on the side that is directed toward the outside of the container 1.

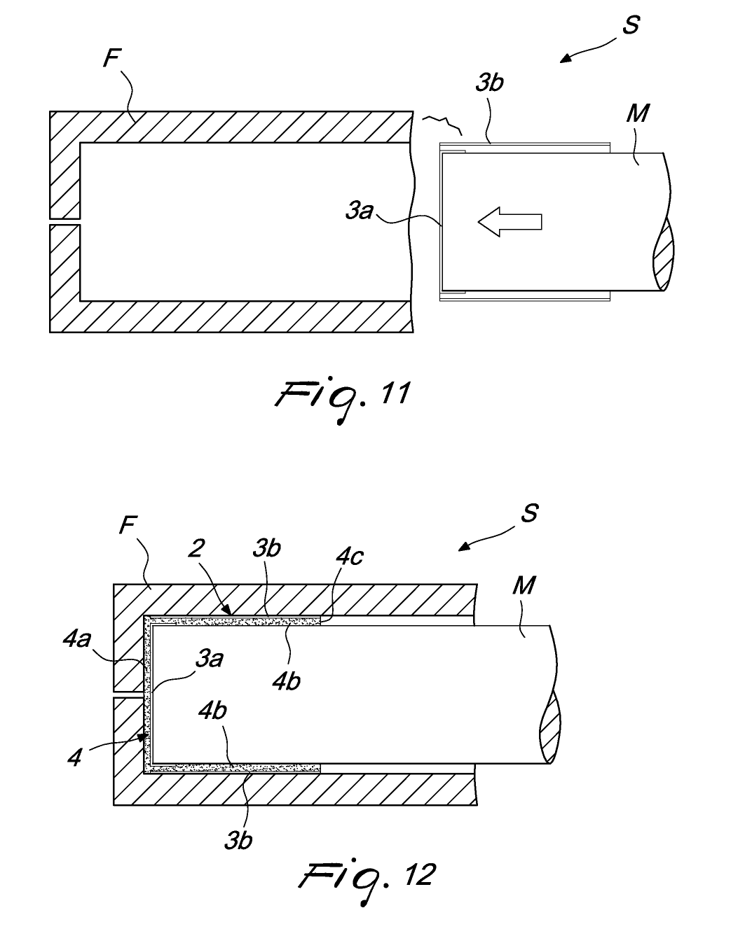

The method for obtaining the container 1 (FIGS. 9-12) entails:
shaping by die-cutting the first barrier element 3a, which has a larger extension than the bottom wall 4a, and the second barrier element 3b, which is band-shaped, from a flexible aluminum sheet;
arranging the first barrier element 3a at the bottom of the plug that acts as a male mold half M and the second barrier element 3b so that it is wrapped with play around such plug. The second barrier element 3b can be sealed along the opposite sides so as to obtain a closed band. The first barrier element 3a is kept in position by means of the vacuum produced inside the male mold half M (which is internally hollow) and the perimetric portion that protrudes beyond the extension of the bottom wall 4a must be folded onto the plug and surmounted by the second barrier element 3b;
closing the mold S, by moving the male mold part M and the female mold part F closer to each other;
injecting plastic material into the mold S. The injected material flows through the gap formed between the edge of the first barrier element 3a, which is folded onto the male mold half M and the second barrier element 3b, pressing them in contact respectively with the male mold half M and with the wall of the female mold half F;
shaping the stiffening structure 2 made of plastics inside the mold S directly in contact with the barrier elements 3a and 3b to which sealing is performed. The stiffening structure 2 that is obtained is jointly connected directly and integrally (i.e., on the entire surface in contact) with the barrier elements 3a and 3b so as to obtain a barrier-type container 1.

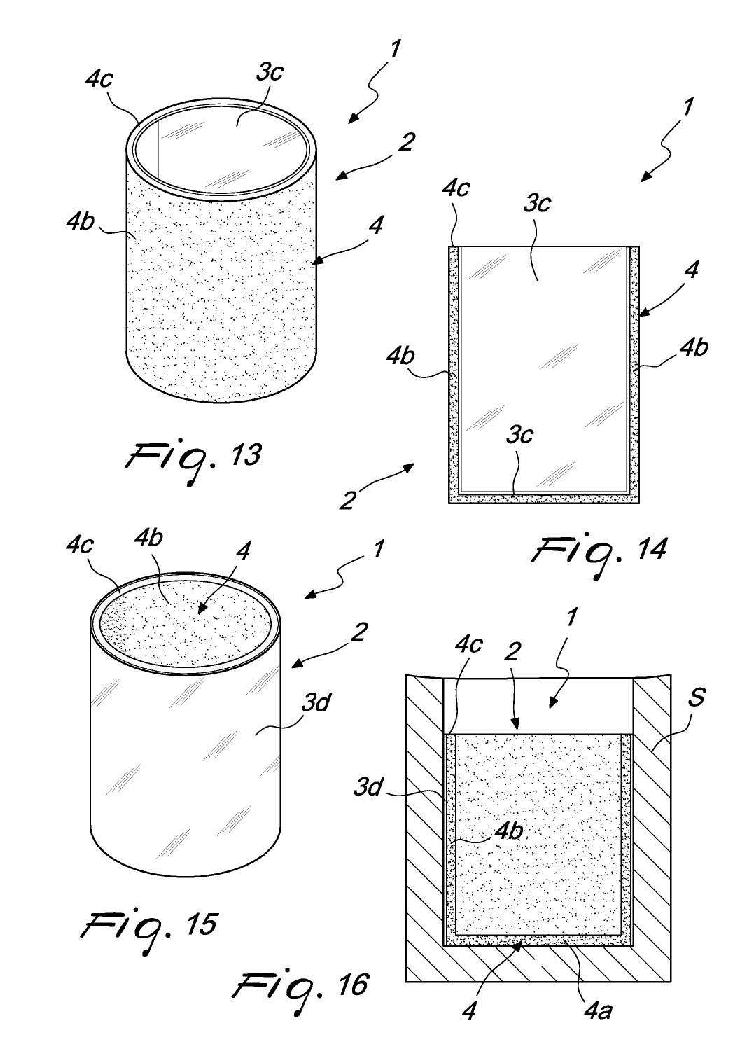

In a third embodiment (FIGS. 13-14), the barrier element 3c consists of an enclosure whose shape substantially matches the interior of the vessel 4, is arranged inside it and is directly jointly connected thereto at least at the mouth 4c, such vessel being obtained by blow-molding.

The method for the production of the container 1 entails:
shaping at least one barrier element 3 from a flexible aluminum sheet;
sealing such barrier element so as to obtain an enclosure 3c;
shaping the vessel 4 by blow-molding;
arranging the enclosure 3c inside the vessel 4 with the opening at the mouth 4c;
heat-sealing the enclosure 3c to the vessel 4 at least at the mouth 4c so as to obtain a barrier-type container 1.

In this case, the vessel 4 and the enclosure 3c are directly jointly connected at the regions where heat-sealing is performed.

Moreover, in a fourth embodiment (FIGS. 15-16) the barrier element 3d is jointly connected directly and integrally outside the vessel 4 at least at the side wall 4b, such vessel being obtained by blow-molding.

The method for the production of the container 1 entails shaping the barrier element 3d in the form of a band and inserting it in a mold S for blow-molding. As a consequence of the insertion of the portion of extruded plastic material in the mold S, the blow-molding action that causes the expansion and molding of the stiffening structure 2 ensures adhesion of the side wall 4b to the barrier element 3d.

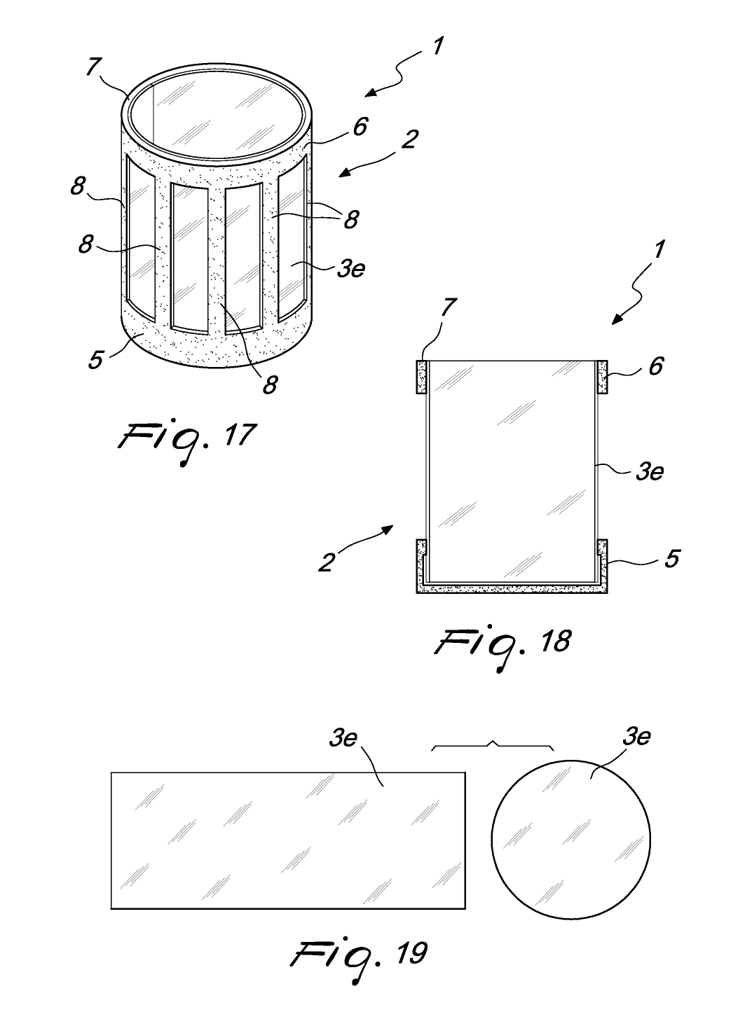

In a fifth embodiment (FIGS. 17-18), the container 1 is of the semirigid type and the stiffening structure 2 comprises a bottom element 5 and a collar 6 which forms an open mouth 7, which are mutually spaced. The stiffening structure 2 can have a plurality of spacers 8 interposed between the bottom element 5 and the collar 6, so as to increase the resistance to crushing of the container 1.

The barrier element 3e consists of an open enclosure whose shape substantially matches the surface delimited by the stiffening structure 2, is arranged inside it and is jointly connected directly and integrally thereto, the stiffening structure 2 being obtained by injection-molding.

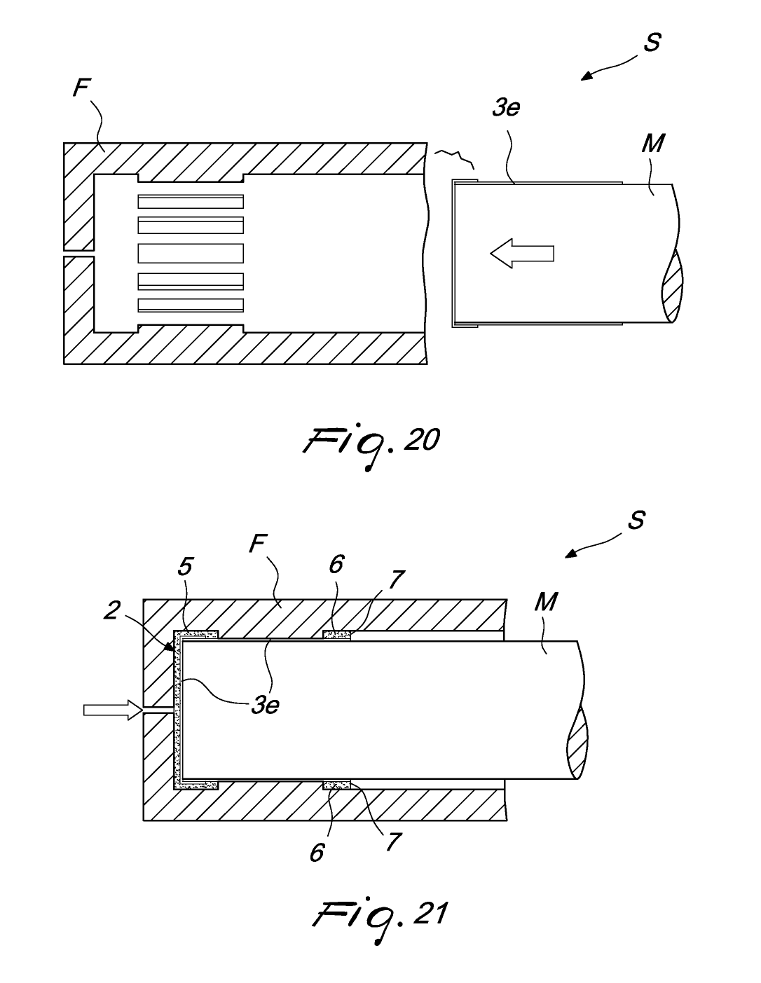

The production method (FIGS. 19-24) of the container 1 entails:
shaping the enclosure 3e, by die-cutting and subsequent heat-sealing of two or more portions of a flexible aluminum sheet;
fitting the enclosure 3e on the plug that acts as a male mold half M and keeping it in position by means of the vacuum provided inside such plug (which is internally hollow);
closing the mold S, moving the male mold half M and the female mold half F closer to each other;
injecting plastics into the mold S;
shaping the stiffening structure 2 made of plastics within the mold S directly in contact with the enclosure 3e, to which it is heat-sealed. The stiffening structure 2 that is obtained is jointly connected directly and integrally (i.e., on the entire surface in contact) with the enclosure 3e so as to obtain a barrier-type container 1.

In this version, separation of the plastics from the metallic material is facilitated for sorted collection of waste and associated recycling.

Finally, the stiffening structure 2 can have a lid 9 which is detachably associated with the mouth 4c or 7 by interlocking or by threaded coupling. The lid 9 has at least one face which is covered by an additional barrier element 3f, which is jointly connected directly and integrally thereto, such lid being obtained by injection-molding.

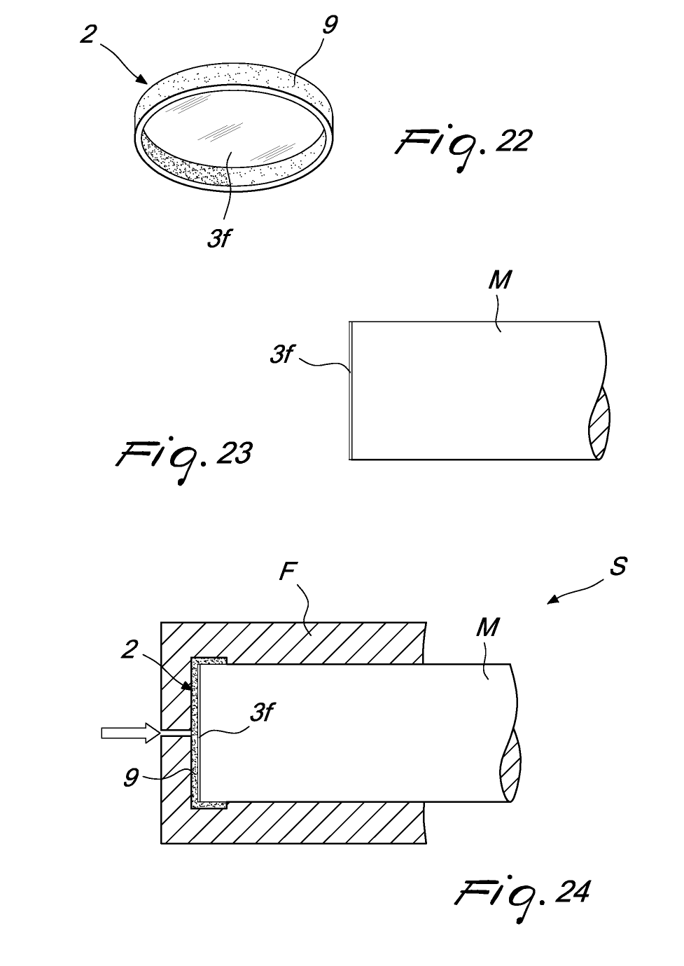

If the lid 9 is covered at the face that is directed toward the inside of the container 1 (FIGS. 22-24), the barrier element 3f obtained by die-cutting is arranged at the bottom of the plug that acts as a male mold half M.

During injection-molding, the lid 9 is heat-sealed onto the barrier element 3f.

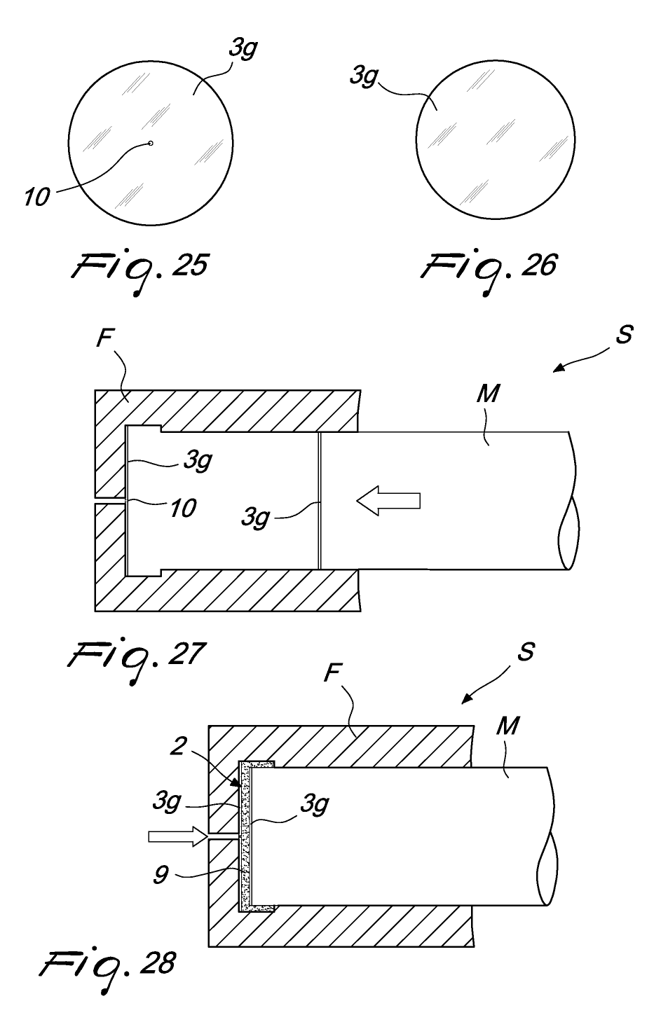

If it is necessary to cover the lid 9 on both faces (FIGS. 25-28), two barrier elements 3e are arranged within the mold S, the one facing the bottom of the female mold half F being provided with one or more micro-perforations 10 in order to allow the passage of the injected plastics.

During the injection of the plastics, it flows through the micro-perforation 10, distributing itself between the two barrier elements 3e and pressing them against the respective mold parts, so as to occupy the cavity of the mold S.

As an alternative, one of the two barrier elements 3e can be replaced with a label or the like.

It is noted that the container 1 can have a different shape and different dimensions depending on its intended use and can be shaped so as to form, for example, one or more handles.

Moreover, in the versions in which the packaged product is in contact with the aluminum, the outer stiffening structure can be provided by means of recovered plastics that meets adequate suitability requirements, containing production costs.

In practice it has been found that the described invention achieves the proposed aim and objects, and in particular the fact is stressed that the container according to the invention makes it possible to obtain a barrier-type package of the rigid and semirigid type made of plastics by means of traditional injection-molding or blow-molding processing methods.

The invention thus conceived is susceptible of numerous modifications and variations, all of which are within the scope of the appended claims.

All the details may further be replaced with other technically equivalent elements.

In practice, the materials used, as well as the contingent shapes and dimensions, may be any according to specific requirements of the product to be packaged without thereby abandoning the scope of protection of the appended claims.

The disclosures in Italian Patent Application No. MO2009A000017 from which this application claims priority are incorporated herein by reference.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

1-9. (canceled)

10. A barrier-type container made of plastics, comprising a stiffening structure made of plastics which is obtained by injection-molding or blow-molding and at least two barrier elements made of a flexible aluminum sheet, which are directly joined at least one respective portion, the barrier elements being sealable to at least the stiffening structure, said stiffening structure comprising a vessel provided with a bottom wall from which a lateral wall protrudes which forms, on the side opposite to said bottom wall, an open mouth, said at least two barrier elements comprising a first element for covering said bottom wall and a second element for covering said side wall, said first and second elements being monolithically connected directly and integrally to said vessel, and said vessel being obtained by injection molding, wherein said flexible aluminum sheet from which said barrier elements are obtained is of the double sealing type, treated for coating on the mutually opposite surfaces thereof with coating materials that make it sealable both with the plastic material of which the stiffening structure is made and onto itself.

11. The container according to claim 10, wherein said barrier element consists of an open enclosure whose shape substantially matches the interior of said vessel and is arranged inside it so as to be directly monolithically connected thereto at least at said mouth, the vessel being obtained by blow-molding.

12. The container according to claim 10, wherein said barrier element is monolithically connected directly and integrally to the outside of said vessel at least at said side wall, the vessel itself being obtained by blow-molding.

13. The container according to claim 10, wherein said stiffening structure comprises a bottom element and a collar that forms an open mouth.

14. The container according to claim 13, wherein said stiffening structure comprises a plurality of spacers, which are interposed between said bottom element and said collar.

15. The container according to claim 10, wherein said barrier element consists of an open enclosure whose shape is substantially complementary to a surface delimited by said stiffening structure and is arranged inside it so as to be directly and integrally monolithic therewith.

16. The container according to claim 10, wherein said stiffening structure comprises a lid that is associated detachably with said mouth and has at least one face covered with an additional barrier element, made of flexible aluminum sheet, which is directly connected to said face, the lid cover being obtained by injection molding.

17. A method for manufacturing a barrier-type container made of plastics comprising the steps of:
treating a flexible aluminum sheet so as to make it of a double sealing type by coating on the mutually opposite surfaces thereof a coating material that make said opposite surfaces sealable both with the plastic material of the container and onto itself;
shaping at least two barrier elements made of said double sealing flexible aluminum sheet;
arranging said barrier elements within a forming mold at one of the male or female mold halves;
closing the mold, keeping in position said barrier elements;
feeding plastics into the mold;
shaping a stiffening structure made of plastics within said mold that has at least one portion which is directly monolithically connected to said barrier elements, so as to obtain a barrier-type container made of plastics.

18. The method according to claim 17, wherein after the step of shaping said at least two barrier elements a further step is provided for
heat-sealing said barrier elements so as to obtain an open enclosure.
